(19) United States
(12) Patent Application Publication
(10) Pub. No.: US 2011/0279720 A1
(43) Pub. Date: Nov. 17, 2011

(54) SOLID-STATE IMAGING DEVICE AND CAMERA

(75) Inventors: Takuma NAKAGAWA, Osaka (JP); Hiroshi KUBO, Osaka (JP)

(73) Assignee: PANASONIC CORPORATION, Osaka (JP)

(21) Appl. No.: 13/195,293

(22) Filed: Aug. 1, 2011

Related U.S. Application Data
(63) Continuation of application No. PCT/JP2009/007234, filed on Dec. 25, 2009.

(30) Foreign Application Priority Data
Feb. 6, 2009 (JP) 2009-026738

(51) Int. Cl. H04N 5/335

(52) U.S. Cl. 348/300; 348/294; 348/E05.091

(57) ABSTRACT

The solid-state imaging device includes a plurality of pixel units arranged in rows and columns. Each of the pixel units includes: a photodiode that generates a signal voltage corresponding to an intensity of light received; and an amplifier transistor which amplifies the signal voltage in response to a flow of an operating current, and outputs the amplified signal voltage to a column signal line that is provided for each of pixel columns. The solid-state imaging device includes current correction circuits each of which is provided for a corresponding one of the pixel columns and causes a correction current to flow between a power supply line and a grounding line. The correction current fluctuates in an opposite direction to a fluctuation of the operating current flowing into the grounding line from the power supply line via the amplifier element.

### CROSS REFERENCE TO RELATED APPLICATION

This is a continuation application of PCT application No. PCT/JP2009/007234 filed on Dec. 25, 2009, designating the United States of America.

### BACKGROUND OF THE INVENTION

(1) Field of the Invention

The present invention relates to solid-state imaging devices and cameras, and in particular to a solid-state imaging device and a camera which can capture a defect-free high quality image, especially when capturing a subject of high luminance.

(2) Description of the Related Art

A Metal Oxide Semiconductor (MOS) image sensor accumulates, in a gate electrode of a MOS transistor, a photocarrier generated by a photodiode and, according to a drive timing given by a scanning circuit, performs charge amplification on a change of a potential of the gate electrode, and outputs the amplified potential change to an outputting unit. FIG. 10 is a block diagram showing a configuration of a conventional Complementary Metal Oxide Semiconductor (CMOS) solid-state imaging device. Following describes an operation of a CMOS solid-state imaging device 500 shown in FIG. 10. When light incidents to photodiodes D11 to D33 that are included in pixels laid out two-dimensionally, each of photodiodes generates and accumulates a light signal charge. The accumulated light signal charge is, as a signal voltage, sequentially read out to the column signal lines V1 to V3 by a vertical scanning circuit block 501 pixel row by pixel row. For example, when a signal voltage that corresponds to a light signal charge accumulated in D11 is read out to the column signal line V1, a voltage that corresponds to the signal voltage is provided to the column signal line V1 because a load transistor M51 and a MOS transistor M311 that are placed between a power supply line and a grounding line form a source follower circuit.

In the readout operation described above, the stronger the light intensity of the signal voltage to be read out, the lower the voltage of the column signal lines V1 to V3 becomes. The column signal lines V1 to V3 are connected to drains of the load transistors M51 to M53 respectively. Thus, there can be a case where a voltage between a source and a drain of a load transistor for a pixel column in which a signal voltage for strong light intensity is being read out becomes 0 V. At this time, the load transistor becomes in OFF state, and drain current does not flow. Thus, while certain pixel row is being read out, a current that flows into a shared grounding line 510 varies depending on the number of load transistors that are in OFF state. In addition, the grounding line 510 has an impedance of finite value because the line width of the grounding line 510 is restricted due to a constraint of a size of a chip. Thus, a voltage drop caused by the impedance of the grounding line 510 and the current flown into the grounding line 510 varies pixel row from pixel row depending on intensity of incident light.

On the other hand, a value of a constant current that flows in the load transistors M51 to M53 is set by applying a voltage to a gate of an input transistor M50 with respect to a ground potential. The value of the constant current thus set is changed due to the voltage drop described above. For example, since a pixel row which includes a larger number of pixels to which a strong light incidents has a larger number of load transistors which are in OFF state, the voltage drop in the grounding line 510 is small and the value of the constant current becomes larger. This causes a phenomenon that an output voltage of a dark pixel and an optical black pixel is different between a pixel row which includes a pixel to which a strong light incidents and the pixel row which does not include such pixel. In other words, when capturing a subject of high luminance, a problem such as a generation of a highlight horizontal line noise occurs. The highlight horizontal line noise refers to an image defect of white belts or black belts that appear on either side of an area of high luminance.

For the above described problem, Patent Reference 1 (Japanese Unexamined Patent Application Publication No. 2001-230974) discloses a technique in which a clipping transistor is provided for each of column signal lines of a pixel source follower circuit so that the column signal line potential is prevented from becoming lower than a voltage that is determined based on a clipped voltage. The highlight horizontal line noise is thus reduced.

FIG. 11 is a block diagram showing a configuration of a conventional CMOS solid-state imaging device described in Patent Reference 1. Compared to a CMOS solid-state imaging device 500 shown in FIG. 10, the configuration of a CMOS solid-state imaging device 600 shown in FIG. 11 is different only in that a voltage clipping circuit is connected to each of the column signal lines V1 to V3. Following describes the difference, and a description for the same points as the CMOS solid-state imaging device 500 shown in FIG. 10 is omitted.

In the CMOS solid-state imaging device 600, the column signal lines V1 to V3 are connected to sources of clipping transistors M71 to M73 respectively. With this, (i) the clipping transistor M71 has a configuration of differential amplification with amplifier transistors M311 to M313, (ii) the clipping transistor M72 with amplifier transistors M321 to M323, and (iii) the clipping transistor M73 with amplifier transistors M331 to M333. The amplifier transistors M311 to M313, M321 to M323, and M331 to M333 are included in pixels. With the differential amplification thus described, when a difference in two input potentials becomes large, an input transistor on one side is blocked, and a current flows only in an input transistor on the other side. For example, when a subject of high luminance is captured and gate voltages of amplifier transistors M311 to M333 that are included in pixels are, respectively, lower than a clipped voltage V_{CG} that is set for gates of the clipping transistors M71 to M73, the clipping transistors M71 to M73 become ON state. Thus, a potential of the column signal lines V1 to V3 are limited and does not be equal to or lower than the voltage determined by the clipped voltage V_{CG}. With this, by suppressing the fluctuation of drain current in the load transistors M51 to M53, fluctuation of voltage drop in the grounding line 510 which occurs to the CMOS solid-state imaging device 500 is suppressed. Thus, according to Patent Reference 1, it is possible to suppress a deviation of black level, and thus the highlight horizontal line noise can be reduced.

With the CMOS solid-state imaging device 600 described in Patent Reference 1, the clipping transistors M71 to M73 become ON state if the subject is in a range where amount-of-light is saturated, and thus advantage of reducing the highlight horizontal line noise is achieved.

### SUMMARY OF THE INVENTION

However, the CMOS solid-state imaging device 600 cannot suppress the highlight horizontal line noise when a subject is in a range where amount-of-light is not saturated, that is, when the subject is in a range where amount-of-light is low to middle or the like. This is because gate voltages of the amplifier transistors M311 to M333 inside pixels become higher than the clipped voltage V_{CG}, and thus the clipping transistor does not become ON state.

Moreover, the clipping transistors are provided for each of the columns. Thus, due to variations in threshold voltage of the clipping transistors, the voltage at which the clipping transistor becomes ON state varies from pixel column to pixel column. The variation in the voltage causes a longitudinal line to appear on an image, which is an other image defect.

The present invention has been conceived in view of the aforementioned problems, and has an object to provide a solid-state imaging device which effectively reduces the highlight horizontal line noise without generating an image defect in a form of a longitudinal line, regardless of a range of amount-of-light the subject may be in.

To solve the above described problems, a semiconductor device according to an aspect of the present invention is a solid-state imaging device in which a plurality of pixel units are arranged in rows and columns, each of the pixel units including a light-receiving element that generates a signal voltage corresponding to an intensity of light received, wherein each of the pixel units includes an amplifier element which amplifies the signal voltage in response to a flow of an operating current, and outputs the amplified signal voltage to a column signal line that is provided for each of pixel columns. The solid-state imaging device includes current correction units each of which is provided for a corresponding one of the pixel columns and configured to cause a correction current to flow between a power supply line and a grounding line, the correction current fluctuating in an opposite direction to a fluctuation of the operating current flowing into the grounding line from the power supply line via the amplifier element.

According to this aspect, in a certain pixel row, even when an operating current which flows in a certain column signal line fluctuates corresponding to an amount of light received by a pixel unit, the correction current that is caused to flow by the current correction unit provided for each of the pixel columns allows a voltage fluctuation in a power supply line and a grounding line to be suppressed within the pixel column. Thus, the operating current which flows in an other column signal line is not affected by the voltage fluctuation. With this, regardless of the amount of incident light, it is possible to reduce the highlight horizontal line noise.

Furthermore, preferably, each of the current correction units includes a correction current generating circuit which causes the correction current to flow between the power supply line and the grounding line, the correction current being generated based on a fluctuation in potential of the column signal line.

Further, preferably, at least one of the current correction units includes a reference current generating circuit which causes a constant reference current to flow between the power supply line and the grounding line, wherein the correction current generating circuit causes the correction current to flow between the power supply line and the grounding line, the correction current being generated based on a current-mirror current of the reference current and a fluctuation in potential of the column signal line.

According to this aspect, the correction current is generated not by limiting the operating current which flows in the column signal line. Thus, an image defect in a form of a longitudinal line, which is generated when a threshold is set for each of the pixel columns to limit the operating current, is not generated.

Furthermore, the solid-state imaging device may include: the amplifier element which is a first amplifier transistor which includes a gate connected to a floating diffusion of a corresponding one of the pixel units, and a source and a drain one of which is connected to the power supply line, and which amplifies the signal voltage and outputs the amplified signal voltage to the column signal line from the other of the source and the drain; a first load transistor which includes a gate to which a bias voltage is applied, and a source and a drain one of which is connected to the column signal line and the other of the source and the drain is connected to the grounding line, the first load transistor generating the operating current; the reference current generating circuit which includes (i) a second load transistor which includes a gate to which a bias voltage is applied, and a source and a drain one of which is connected to the grounding line, the second load transistor generating the reference current and (ii) a first current mirror transistor which includes a gate, and a source and a drain one of which is connected to the power supply line and the other of the source and the drain is connected to the other of the source and the drain of the second load transistor, the gate and the other of the source and the drain of the first current mirror transistor being short circuited; and the correction current generating circuit which includes (i) a second amplifier transistor which includes a gate connected to the one of the source and the drain of the first load transistor, and a source and a drain one of which is connected to the grounding line, the second amplifier transistor giving a potential that corresponds to a fluctuation in potential of the column signal line to the other of the source and the drain and (ii) a second current mirror transistor which includes a source and a drain one of which is connected to the power supply line and the other of the source and the drain is connected to the other of the source and the drain of the second amplifier transistor, and a gate connected to the gate of the first current mirror transistor, the second current mirror transistor generating the correction current.

According to this aspect, different from the source follower circuit which includes an amplifier element using a Field Effect Transistor (FET), the current correction unit includes: a current mirror circuit using an FET; and a source follower circuit using an FET. Thus, the current correction unit can generate the reference current and the correction current that reflect the operating current accurately, without depending on a threshold voltage of the transistor. Furthermore, the current correction unit to be added can be formed at the same time when the pixel unit and the above described amplifier element are formed.

Furthermore, preferably, a value of a bias voltage applied to the gate of the first load transistor is the same as a value of a bias voltage applied to the gate of the second load transistor.

According to this aspect, the bias voltage supplied to the first load transistor of the amplifying unit and the bias voltage supplied to the second load transistor of the reference current generating circuit do not need to be independently adjusted. Thus, a load for driving is reduced.

Furthermore, an amount of a fluctuation in a current, which is a sum of the operating current and the correction current, is smaller than an amount of a fluctuation in the operating current.

According to this aspect, the highlight horizontal line noise is reduced.

Furthermore, preferably, the current correction unit generates the correction current for full range of the intensity of light received.

According to this aspect, the highlight horizontal line noise is reduced regardless of a brightness of a subject.

Furthermore, at least one of the current correction units may include a correction current ON/OFF circuit which switches between generation and non-generation of the correction current performed by the current correction unit.

According to this aspect, it is possible to switch the state of the current correction unit between driven and non-driven. Thus, it is possible to lower power consumption compared to the case where the correction current is constantly caused to flow to constantly drive the current correction unit.

In addition, the present invention can be realized not only as the solid-state imaging device having the above described characteristics but also as a camera including the solid-state imaging device. Here, the camera has the same configuration as described above and produces the same advantageous effect as described above.

A camera according to another aspect of the present invention is a camera which includes a solid-state imaging device in which at least one of the current correction units includes a correction current ON/OFF circuit which switches between generation and non-generation of the correction current performed by the current correction unit, and the solid-state imaging device further includes a column amplifier circuit which is connected to the column signal line and amplifies, for each of the pixel columns, by switching between a plurality of gains, a voltage outputted to the column signal line, the camera including a control unit configured to control the following switching operations in conjunction with each other: (i) the switching between gains performed by the column amplifier circuit and (ii) the switching between generation and non-generation of the correction current performed by the correction current ON/OFF circuit.

According to this aspect, it is possible to control the following switching operations in conjunction with each other: (i) the switching between gains of the column amplifier circuit and (ii) the switching between ON/OFF of the current correction unit. For example, when a gain of the column amplifier circuit is high, an impact to an image quality made by the highlight horizontal line noise, which is generated due to a fluctuation of the operating current of the amplifier circuit, is significant. On the other hand, when the above described gain is low, an impact to an image quality made by a fluctuation of the above described operating current is not significant. Thus, by controlling the current correction unit such that the current correction unit is driven when the above described gain is high and the current correction unit is not driven when the gain is low, it is possible to suppress an increase of power consumption while reducing the highlight horizontal line noise effectively.

Furthermore, further, a camera according to this aspect may include a gain amplifier which adjusts, with an appropriate gain, a gain of an image output voltage that corresponds to a voltage outputted by the solid-state imaging device, wherein the control unit may control, according to a gain of the gain amplifier, the switching between generation and non-generation of the correction current performed by the correction current ON/OFF circuit.

According to this aspect, it is possible to suppress the power consumption effectively. For example, the current correction unit may be switched to a driven state when a gain of the gain amplifier is high, and the current correction unit may be switched to a non-driven state when a gain of the gain amplifier is low.

The solid-state imaging device according to the present invention allows reduction in fluctuation in current that flows in the column signal line when capturing a subject, regardless of an amount of light a subject may have. Furthermore, according to the current correction circuit included in the solid-state imaging device according to the present invention, fluctuation in current can be suppressed without limiting an output of the column signal line. Thus, an image defect in a form of a longitudinal line is not generated. Consequently, regardless of the brightness of a subject, it is possible to obtain an image which has less highlight horizontal line noise, without generating an image defect in a form of a longitudinal line. Furthermore, according to a camera equipped with the solid-state imaging device in the present invention, it is possible to control, based on gains of the column amplifier circuit or the gain amplifier, whether or not to drive the current correction circuit. This enables to suppress the increase in power consumption while reducing the highlight horizontal line noise effectively.

### FURTHER INFORMATION ABOUT TECHNICAL BACKGROUND TO THIS APPLICATION

The disclosure of Japanese Patent Application No. 2009-026738 filed on Feb. 6, 2009 including specification, drawings and claims is incorporated herein by reference in its entirety.

The disclosure of PCT application No. PCT/JP2009/007234 filed on Dec. 25, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is an outline diagram showing a configuration of a solid-state imaging device according to Embodiment 1 of the present invention;

FIG. 2 is a circuit configuration diagram showing a pixel array of the solid-state imaging device and a source follower circuit according to Embodiment 1 of the present invention;

FIG. 3 is a circuit diagram of a current correction circuit included in the solid-state imaging device according to Embodiment 1 of the present invention;

FIG. 4 is a graph showing a channel length modulation effect of a MOS transistor;

FIG. 5 is a block diagram showing the pixel array of the solid-state imaging device, a pixel source follower circuit, and a column amplifier circuit according to Embodiment 1 of the present invention;

FIG. 6 is a circuit configuration diagram showing a pixel array of a solid-state imaging device and a pixel source follower circuit according to Embodiment 2 of the present invention;

FIG. 7 is a functional block diagram showing a camera according to Embodiment 3 of the present invention;

FIG. 8 is a circuit configuration diagram showing a current correction circuit included in a solid-state imaging device according to Embodiment 3 of the present invention;

FIG. 9 is a circuit configuration diagram showing a column amplifier circuit included in the solid-state imaging device according to Embodiment 3 of the present invention;

FIG. 10 is a block diagram showing a configuration of a conventional CMOS solid-state imaging device; and

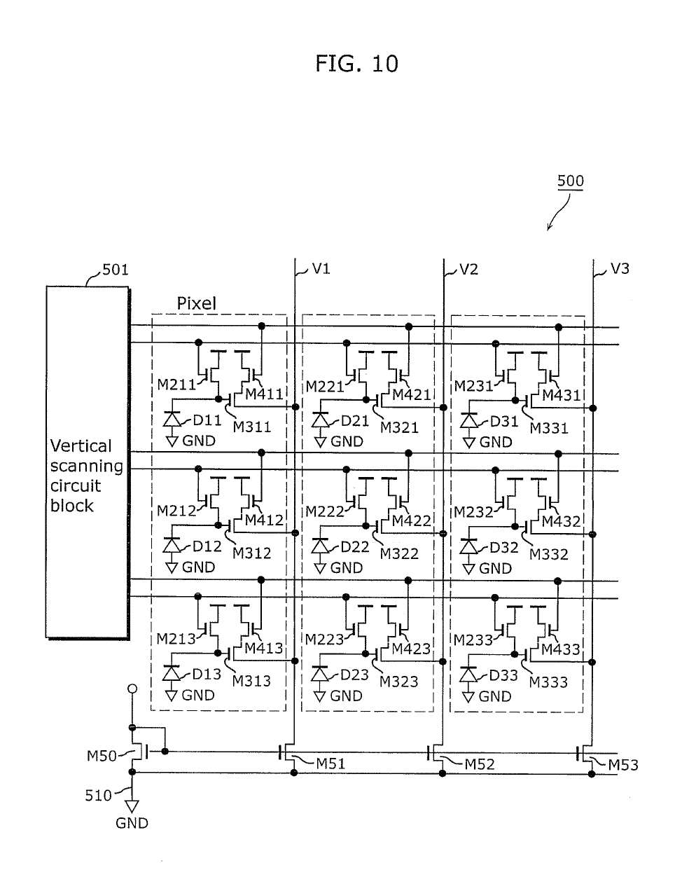

FIG. 11 is a block diagram showing a configuration of the conventional CMOS solid-state imaging device described in Patent Reference 1.

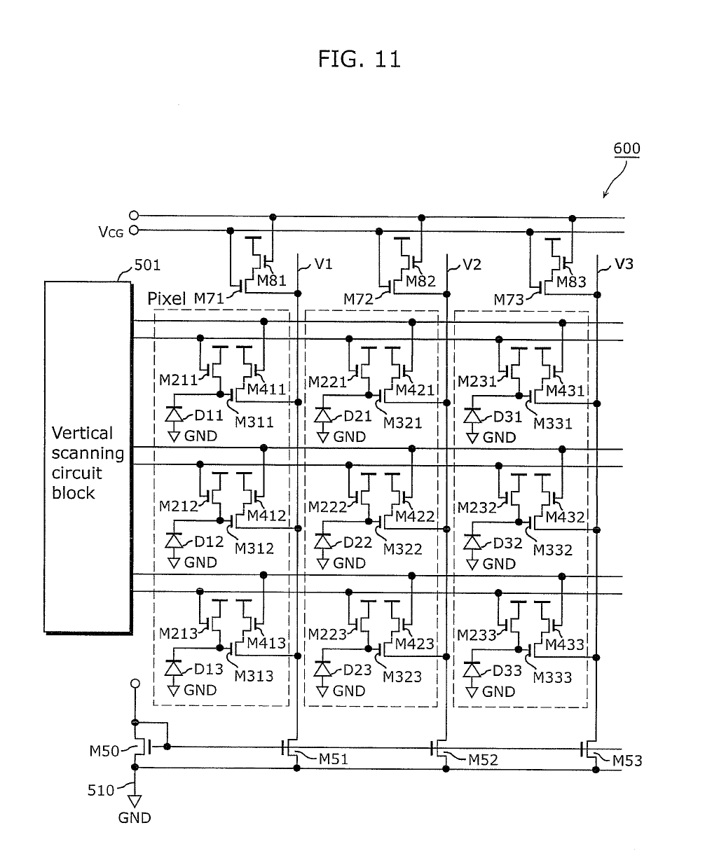

### DESCRIPTION OF THE PREFERRED EMBODIMENTS

### Embodiment 1

A solid-state imaging device according to this embodiment includes pixel units arranged in rows and columns. Each of the above described pixel units includes an amplifier element which amplifies a signal voltage, which has been generated by a photoelectric conversion, in response to a flow of an operating current, and outputs an amplified signal voltage to a column signal line which is provided for each of pixel columns. Further, the above described solid-state imaging device includes current correction units each of which is provided for a corresponding one of the pixel columns and configured to cause a correction current to flow between a power supply line and a grounding line, the correction current fluctuating in an opposite direction to a fluctuation of the operating current flowing into the grounding line from the power supply line via the amplifier element. With this, regardless of the amount of incident light, it is possible to reduce a highlight horizontal line noise.

Following describes Embodiment 1 according to the present invention in detail with reference to drawings.

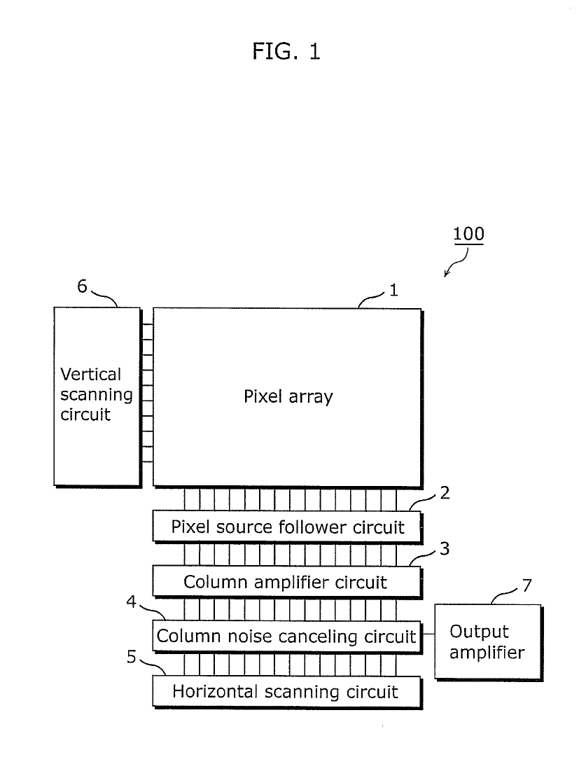

FIG. 1 is an outline diagram showing a configuration of a solid-state imaging device according to Embodiment 1 of the present invention. A solid-state imaging device 100 shown in FIG. 1 includes a pixel array 1, a pixel source follower circuit 2, a column amplifier circuit 3, a column noise canceling circuit 4, a horizontal scanning circuit 5, a vertical scanning circuit 6, and an output amplifier 7.

The pixel array 1 includes pixel units which are arranged in rows and columns.

The pixel source follower circuit 2 includes an amplifying unit which amplifies a pixel signal generated in each of pixel units included in the pixel array 1.

The column amplifier circuit 3 amplifies, for each of the columns, further the signal which has been amplified by the pixel source follower circuit 2.

The column noise canceling circuit 4 subtracts variation in offset for each of the rows, and holds pixel signals included in one column.

The horizontal scanning circuit 5 sequentially selects and reads out pixel signals included in one column that are held by the column noise canceling circuit 4.

The vertical scanning circuit 6 performs, row by row, a reset of the pixel signals, accumulation of electric charge, and control of readout operation.

The output amplifier 7 sequentially outputs pixel signals included in one column that are held by the column noise canceling circuit 4, to outside of a sensor.

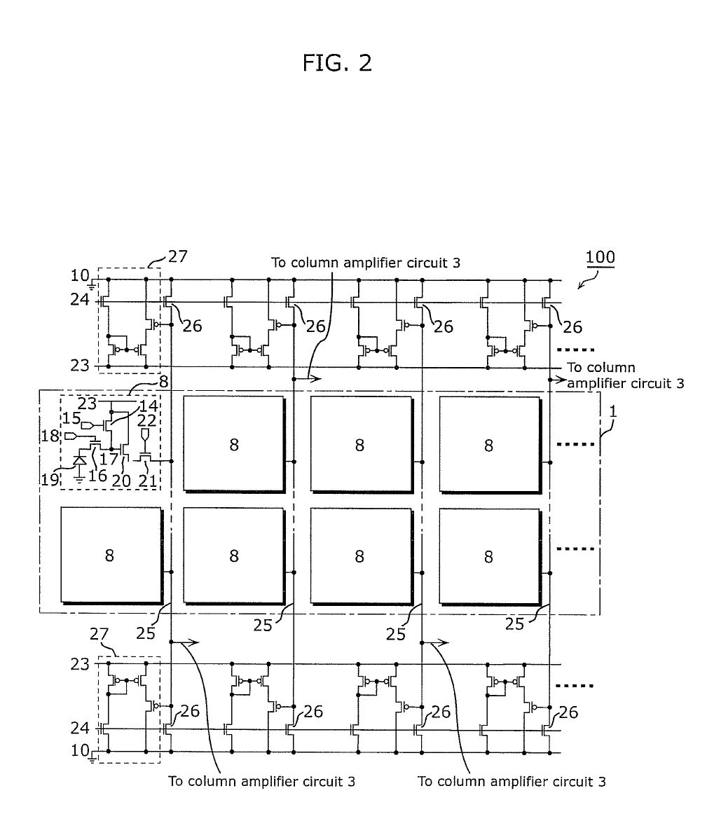

FIG. 2 is a circuit configuration diagram showing a pixel array of the solid-state imaging device and a source follower circuit according to Embodiment 1 of the present invention. The pixel array 1 is composed of pixel units 8 arranged in rows and columns. The solid-state imaging device 100 further includes column signal lines 25. Each of the column signal lines 25 are provided for a corresponding one of the columns of the pixel units 8 arranged in rows and columns.

Each of the pixel units 8 includes: a photodiode 19 which generates light signal charge by performing a photoelectric conversion; a floating diffusion 17 which converts the light signal charge generated by the photodiode 19 into a signal voltage; a transfer transistor 16 which transfers the light signal charge generated by the photodiode 19 to the floating diffusion 17; a reset transistor 14 for resetting the signal voltage generated by the floating diffusion 17; an amplifier transistor 20 which amplifies the signal voltage generated by the floating diffusion 17; and a pixel selection transistor 21 which selects a pixel row by row.

The reset transistor 14 has a drain connected to a power supply line 23 that is provided to be shared by all the pixel units 8, a source connected to the floating diffusion 17, and a gate connected to a pixel reset signal line 15 which is provided for each of the pixel rows.

In addition, the transfer transistor 16 has a drain connected to the floating diffusion 17, a source connected to the photodiode 19, and a gate connected to a charge transfer signal line 18 which is provided for each of the pixel rows.

In addition, the amplifier transistor 20 has a drain connected to power supply line 23, a source connected to the pixel selection transistor 21, and a gate connected to the floating diffusion 17.

In addition, the pixel selection transistor 21 has a drain connected to the amplifier transistor 20, a source connected to the column signal line 25 which is provided for each of the pixel column, and a gate connected to a pixel select signal line 22 which is provided for each of the pixel rows.

With the above described configuration, in the pixel unit 8, a signal voltage that corresponds to the light signal charge which is generated by the photodiode 19 corresponding to an intensity of light received.

The amplifier transistor 20 in the pixel unit 8 is a N-type Metal Oxide Semiconductor (NMOS) first amplifier transistor, and further, the amplifier transistor 20 and a constant current transistor 26 form the amplifying unit that is included in the pixel source follower circuit 2. According to this embodiment, the constant current transistor 26 is provided above and below the pixel array 1 for each of the pixel columns. Furthermore, the constant current transistor 26 has one of a source and a drain connected to a source of the pixel selection transistor 21 via the column signal line 25, and the other of the source and the drain connected to a grounding line 10, and a gate connected to a shared bias supply line 24.

The constant current transistor 26 is a NMOS first load transistor included in the pixel source follower circuit 2, and has a gate to which a bias voltage is applied and operates in a saturation range, and causes a constant operating current to flow in the column signal line 25. With this, an image signal voltage that corresponds to the signal voltage applied to the gate of the amplifier transistor 20 is read out to the column signal line 25, and outputted to the column amplifier circuit 3. However, the above described operating current provided by the constant current transistor 26 is fluctuated due to a channel length modulation effect of the constant current transistor 26, and consistency in constant current is lost.

Thus, with the conventional solid-state imaging device, because the consistency in constant current of the operating current that flows in the column signal line is lost, a current that flows into the shared grounding line varies row by row during readout of a certain pixel column. In addition, the grounding line has an impedance of finite value because the line width of the grounding line is restricted due to a constraint of a size of a chip. Thus, a voltage drop, which is caused by the above described impedance and a fluctuated current that flows into the grounding line, is different pixel row by pixel row and pixel column by pixel column. The voltage drop is also changed depending on an intensity of incident light. With this, a voltage fluctuation of the grounding line generated in certain pixel column also affects an other pixel column, causing a fluctuation of operating current of the column signal line that is provided for the other pixel column.

In contrast, the pixel source follower circuit 2 in the present invention includes, in addition to the amplifying unit, the current correction circuit 27 provided for each of the pixel columns. The current correction circuit 27 is a stage ahead of the column amplifier circuit 3, and is provided between the power supply line 23 and the grounding line 10 to suppress current fluctuation in the column signal line 25. According to this embodiment, the current correction circuit 27 is provided above and below the pixel array 1 for each of the pixel columns. It is to be noted that each of the pixel columns may include one constant current transistor 26 and one current correction circuit 27.

With this configuration, the solid-state imaging device 100 according to this embodiment can prevent the highlight horizontal line noise from being generated, even when consistency in constant current is lost in the column signal line 25, which is connected to the pixel source follower circuit 2, due to the current fluctuation caused by the channel length modulation effect of the constant current transistor 26. Operation of the current correction circuit 27 will be described in detail.

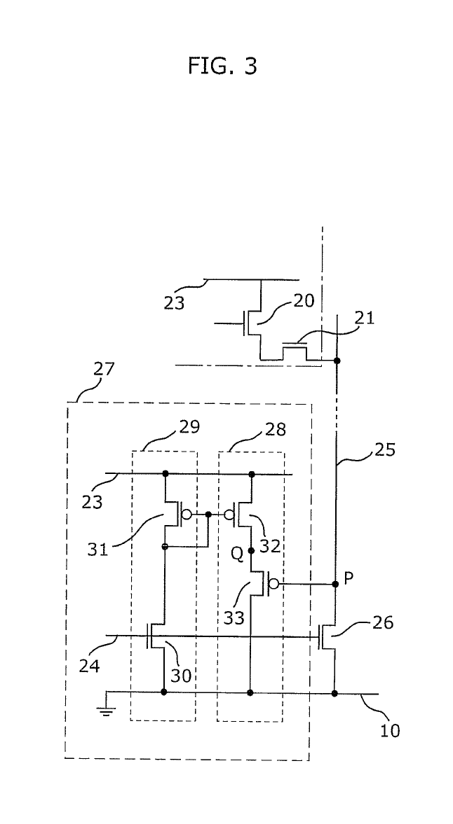

FIG. 3 is a circuit diagram showing a current correction circuit included in the solid-state imaging device according to Embodiment 1 of the present invention. The current correction circuit 27 shown in FIG. 3 is a current correction unit which includes the correction current generating circuit 28 and a reference current generating circuit 29.

The correction current generating circuit 28 is a PMOS source follower circuit, and includes a PMOS current mirror transistor 32 and a PMOS amplifier transistor 33.

The reference current generating circuit 29 includes a PMOS current mirror transistor 31 and a constant current transistor 30.

The current mirror transistor 31 and the current mirror transistor 32 are, respectively, a first current mirror transistor and a second current mirror transistor which form a current mirror circuit. Furthermore, a source of the current mirror transistor 31 and a source of the current mirror transistor 32 are connected to the power supply line 23, and a gate of the current mirror transistor 31 and a gate of the current mirror transistor 32 are connected to each other. Furthermore, a gate of the current mirror transistor 31 and a drain of the current mirror transistor 31 are short circuited.

The constant current transistor 30 is a NMOS second load transistor, and has a source and a drain one of which is connected to the drain of the current mirror transistor 31 and the other of the source and the drain is connected to the grounding line 10, and a gate connected to the bias supply line 24.

The amplifier transistor 33 is a PMOS second amplifier transistor, and has a gate connected to the one of a source and a drain of the constant current transistor 26, a source connected to a drain of the current mirror transistor 32, and a drain of the amplifier transistor 33 connected to the grounding line 10.

According to this embodiment, as shown in FIG. 2, the current correction circuit 27, which includes the correction current generating circuit 28 and the reference current generating circuit 29, is provided above and below of the each of the pixel columns.

Here, when the constant current transistors 26 and 30 are of the same transistor size, the same bias potential is supplied to the constant current transistors 26 and 30 via the bias supply line 24. Since both the constant current transistors 26 and 30 are connected between the power supply line 23 and the grounding line 10, a reference current that flows to the reference current generating circuit 29 does not depend on a threshold voltage but reflects the operating current that flows in the column signal line 25. Furthermore, with this, the bias voltages supplied to the pixel source follower circuit 2 and the current correction circuit 27 do not have to be independently adjusted. Thus, it is possible to reduce the load for driving.

Furthermore, the current mirror transistors 31 and 32 forms the current mirror circuit, and thus can copy, to the correction current generating circuit 28, the current of the column signal line 25 without depending on the threshold voltage but depending only on a size of the transistor.

Here, between a NMOS source follower circuit, which is composed of NMOS amplifier transistor 20 and the constant current transistor 26, and a PMOS source follower circuit, which is composed of a PMOS amplifier transistor 33 and the current mirror transistor 32 which serves as a constant current transistor, direction of fluctuation that occurs in drain current is opposite. Following describes the detail.

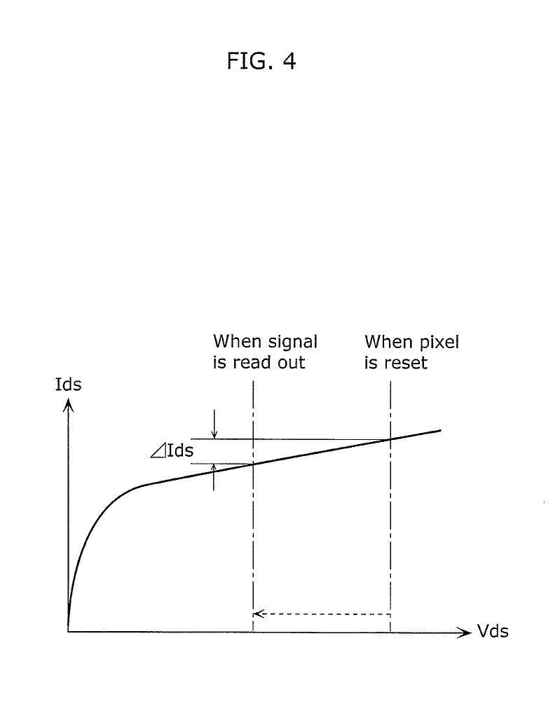

FIG. 4 is a graph showing a channel length modulation effect of a MOS transistor. A horizontal axis represents a voltage Vds between a drain and a source of the MOS transistor, and a vertical axis represents a drain current Ids. The MOS transistor is used as a constant current element in a saturation range where a fluctuation in the drain current Ids is small. However, a drain current Ids fluctuates depending on the Vds voltage, even when the MOS transistor is in the saturation range. For example, a current that flows in the column signal line fluctuates by Aids between a time when a pixel is reset and a time when a signal is read out. This current fluctuation is generated in the constant current transistor 26 shown in FIG. 3. In other words, an image signal voltage which is outputted by the pixel unit 8 and applied between the source and the drain of the constant current transistor 26 fluctuates corresponding to an amount of light irradiated to the photodiode 19. The image signal voltage also fluctuates between the time when the pixel is reset and the time when the signal is read out.

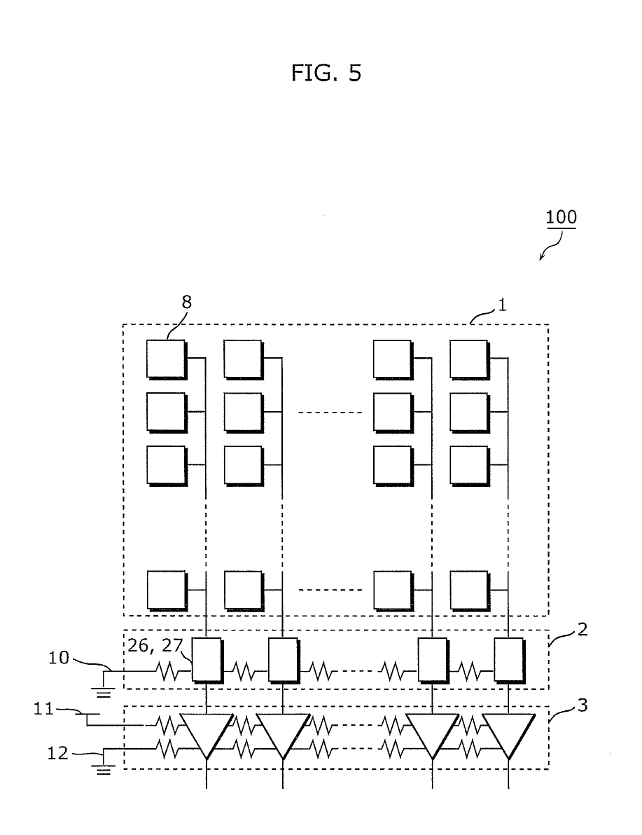

FIG. 5 is a block diagram showing a pixel array of the solid-state imaging device, a pixel source follower circuit, and a column amplifier circuit according to Embodiment 1 of the present invention. As shown in FIG. 5, in the solid-state imaging device 100 according to the present invention, due to a constraint of a size of a chip, the grounding line 10 of the pixel source follower circuit 2, a power supply line 11 of the column amplifier circuit 3, and a grounding line 12 of the column amplifier circuit 3 are, respectively, connected to be shared by all the pixel columns and, furthermore, widths of the lines are constrained. This means that impedance of finite value is generated (i) between the pixel source follower circuits 2 that is provided for each of column signal lines and the grounding line 10, (ii) between the column amplifier circuits 3 that is provided for each of column signal lines and the power supply line 11, and (iii) between the column amplifier circuits 3 that is provided for each of the column signal lines and the grounding line 12.

Because of the above described current fluctuation of the constant current transistor and the presence of the impedance, there is a possibility that the potential of the grounding line 10, the grounding line 12, and the power supply line 11 is fluctuated.

To this, the solid-state imaging device 100 according to the present invention has a configuration in which a current fluctuation in the direction opposite to the fluctuation in drain current of the constant current transistor 26 is generated in each of the pixel columns, and thus it is possible to suppress the effect of the current fluctuation generated between column signal lines.

Referring to FIG. 3, the current correction circuit 27 causes the reference current generating circuit 29 to generate a constant reference current. Furthermore, the amplifier transistor 33 of the correction current generating circuit 28 which mirrors the current that flows in the reference current generating circuit 29 has a gate connected to a P point that is one of the source and the drain of the constant current transistor 26.

In this case, for example, it is assumed that a strong light incidents to the photodiode 19 of the pixel unit 8 causing a change in a signal voltage, and a potential at P point drops by ΔVdc. This causes a voltage between the source and the drain of the constant current transistor 26 to be smaller by the ΔVdc. Thus, due to the channel length modulation effect, a drain current Idc of the constant current transistor 26 also decreases by ΔIdc. Due to the change ΔIdc and resistance components shown in FIG. 5, a voltage drop occurs in the grounding line 10.

On the other hand, in FIG. 3, a Q point, which is a source potential of the amplifier transistor 33, has a potential corresponding to the P point. Thus, a potential of Q point is lower by the voltage corresponding to the ΔVdc. With this, Vdc of the current mirror transistor 32 becomes larger by the voltage corresponding to the ΔVdc. With this, due to the channel length modulation effect, the drain current that flows in the current mirror transistor 32 is increased by the current corresponding to the ΔIdc. To put it differently, the current correction circuit 27 supplies, between the power supply line 23 and the grounding line 10, a correction current that fluctuates to the direction opposite to the fluctuation of the operating current that flows in the column signal line 25. Furthermore, an amount of a fluctuation in a current, which is a sum of the operating current that fluctuates and the correction current, is smaller than an amount of a fluctuation in the operating current.

Therefore, current increased corresponding to ΔIdc flows into impedance R, and thus the fluctuation in voltage drop in the grounding line 10 described above is mitigated.

In other words, the drain current of the current mirror transistor 32 decreases when the drain current of the constant current transistor 26 increases, and the drain current of the current mirror transistor 32 increases when the drain current of the constant current transistor 26 decreases.

With the operation of current correction performed by the current correction circuit 27, it is possible to suppress the fluctuation of a potential of the grounding line 10.

Furthermore, with the similar advantage, it is possible to suppress the fluctuation of potential of the power supply line 23.

Thus, in certain pixel row, even when a current that flows in certain column signal line fluctuates corresponding to an amount of light irradiated to a photodiode, the current flowing in an other column signal line is not affected by the fluctuation and does not fluctuate. With this, by including the current correction circuit 27 between the power supply line 23 of the pixel source follower circuit 2, which is an amplifying unit of the pixel signal, and the grounding line 10, the solid-state imaging device 100 can reduce the highlight horizontal line noise regardless of the amount of incident light.

Further, the current correction circuit 27 does not use the threshold voltage of the MOS transistor to limit an output voltage of the pixel source follower circuit 2. Thus, even when the current correction circuit 27 is provided for each of the pixel columns, the image defect in a form of a longitudinal line caused by the variation in above described threshold voltage is not generated.

As it has been described above, with the solid-state imaging device 100 according to Embodiment 1, when capturing a subject of high luminance and a current fluctuation occurs to the column signal line 25 and the column amplifier circuit 3 which are connected to the pixel unit which received light, it is possible to prevent a fluctuation of a power-supply potential and a ground potential connected to the column signal line 25 and the column amplifier circuit 3 of pixel units adjacent to the pixel unit having received light. Thus, it is possible to prevent the occurrence of deviation of black level in adjacent pixel units described above. To put it differently, the solid-state imaging device 100 according to this embodiment prevents the deviation of black level from occurring, and thereby enables to prevent the occurrence of image defect of highlight horizontal line noise, which is white belts or black belts that appear on either side of an area of high luminance.

Furthermore, the solid-state imaging device 100 according to this embodiment includes the identical current correction circuit 27 above and below each of the pixel columns. Accordingly, when a pixel signal is read out, even when a pixel signal of any pixel columns is read, it is possible to achieve the same current correction effect.

Furthermore, operation of the current correction circuit 27 has been described for the case where the constant current transistor 26 and the constant current transistor 30 have the same transistor size, and the current mirror transistor 31 and the current mirror transistor 32 have the same transistor size. However, the objective of the current correction circuit 27 in this embodiment is to suppress the current fluctuation of the column signal line 25, using the channel length modulation effect of the correction current generating circuit 28. Thus, the size of the transistor does not necessarily have to be the same.

Note that, according to this embodiment, increase in an amount of current that flows in the current correction circuit 27 means that power consumption is increased by that amount. Thus, it is preferable that the current correction circuit is structured to provide high effect in current correction with small amount of current. Thus, use of transistors having narrow channel width and short channel length as the current mirror transistor 32 and the amplifier transistor 33 allows the amount of current flowing in the current correction circuit 27 to be small while achieving a high channel length modulation effect. Thus, by allowing the amount of current flowing in the current correction circuit 27 to be small, it is possible to suppress the increase in power consumption while realizing the current correction circuit having a large current correction effect.

### Embodiment 2

Next, a solid-state imaging device according to Embodiment 2 of the present invention is described with reference to a drawing.

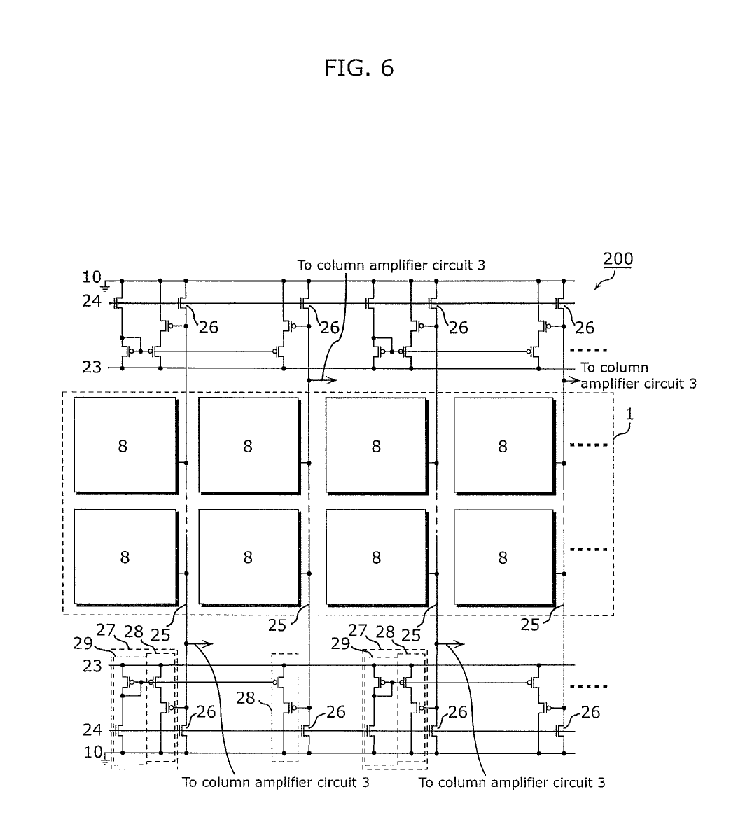

FIG. 6 is a circuit configuration diagram showing a pixel array and a pixel source follower circuit of a solid-state imaging device according to Embodiment 2 of the present invention. The pixel array 1 is composed of pixel units 8 arranged in rows and columns. A solid-state imaging device 200 further includes column signal lines 25. The column signal lines 25 are provided for each of the columns arranged in rows and columns.

The solid-state imaging device 200 according to Embodiment 2 shown in FIG. 6 is the same as the solid-state imaging device 100 according to Embodiment 1 shown in FIG. 2 except for a configuration of a current correction circuit 27. The description of points common to the solid-state imaging device 100 shown in FIG. 2 is omitted, and the following describes only different points.

In the solid-state imaging device 200 shown in FIG. 6, a reference current generating circuit 29 is used in common by adjacent pixel columns. Furthermore, a reference current generated by the reference current generating circuit 29 is copied to the correction current generating circuit 28 which is provided for each of the pixel columns. With this, by allowing the reference current generating circuit 29 to be shared by two pixel columns, it is possible to suppress the increase in consumption current. Thus, according to this embodiment, it is possible to achieve a current correction of the column signal line 25 with low power consumption.

It is to be noted that, in the solid-state imaging device 200 according to Embodiment 2 of the present invention, the number of pixel columns which share the reference current generating circuit 29 is not limited to the two pixel columns, but the reference current generating circuit 29 may be shared by more than two pixel columns.

### Embodiment 3

Next, a solid-state imaging device according to Embodiment 3 of the present invention and a camera which includes the solid-state imaging device are described with reference to drawings.

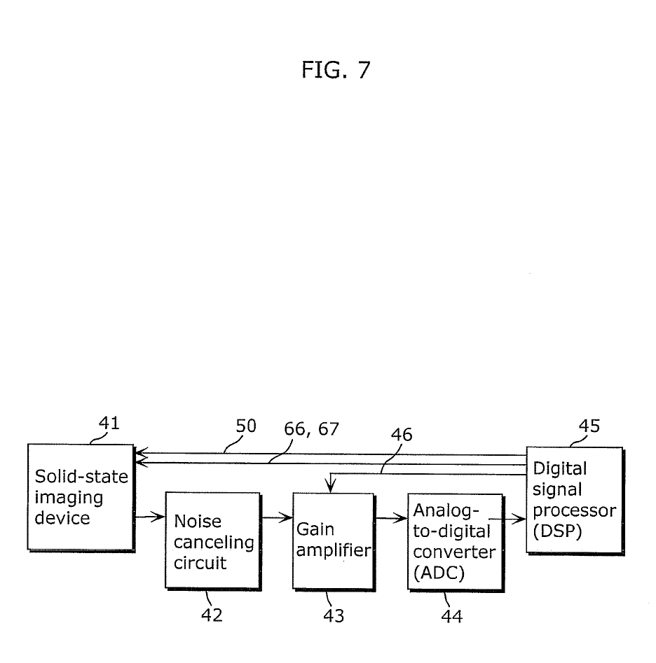

FIG. 7 is a functional block diagram showing a camera according to Embodiment 3 of the present invention. The camera shown in FIG. 7 includes a solid-state imaging device 41, a noise canceling circuit 42, a gain amplifier 43, an analog-to-digital converter (ADC) 44, and a digital signal processor (DSP) 45.

The solid-state imaging device 41 is a solid-state imaging device according to the present invention, and has the same configuration as shown in FIG. 1. Furthermore, the solid-state imaging device 41 is the same as the solid-state imaging device 100 shown in FIG. 2 and the solid-state imaging device 200 shown in FIG. 6, except for a configuration of a current correction circuit. The configuration and an operation of the current correction circuit will be described later. As shown in FIG. 1, an output signal of a pixel source follower circuit which includes the current correction circuit is amplified by a column amplifier circuit pixel column by pixel column. A column noise canceling circuit subtracts variation in offset for each of the pixel columns, and the output signal is read out to an output amplifier.

As shown in FIG. 7, an output signal of the solid-state imaging device 41, which includes from the pixel unit to the output amplifier, is inputted to the DSP45 via the noise canceling circuit 42, the gain amplifier 43, and an ADC 44. The noise canceling circuit 42, the gain amplifier 43, and the ADC 44 are included in an IC that is different from an IC of the solid-state imaging device 41.

The gain amplifier 43 adjusts, with an appropriate gain, a gain of an image output voltage that corresponds to the signal voltage outputted by the solid-state imaging device 41.

Furthermore, the DSP45 is a control unit which controls, in addition to performing an image processing of the output signal, switching between gains of the column amplifier circuit, switching between ON/OFF of a driving of the current correction circuit, and setting of a gain of the gain amplifier 43.

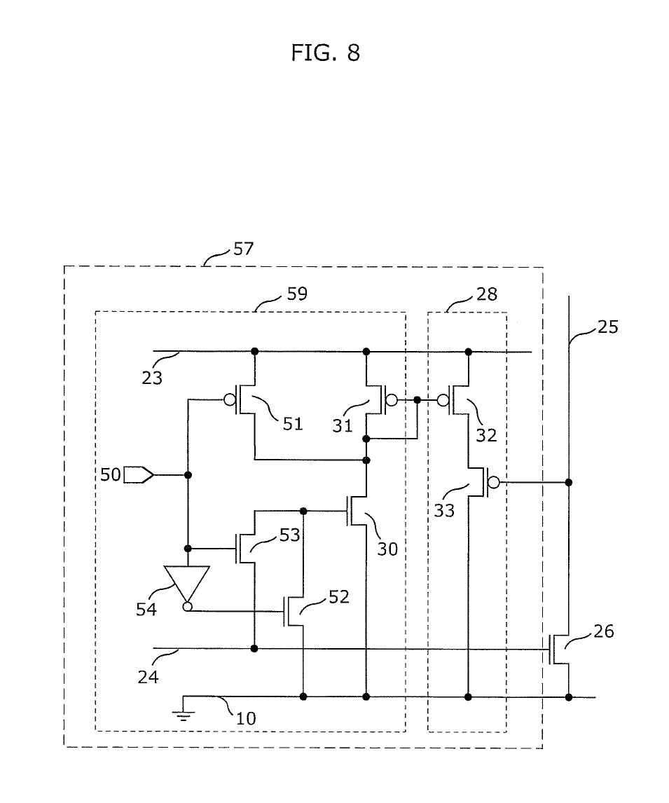

FIG. 8 is a circuit configuration diagram showing a current correction circuit included in a solid-state imaging device according to Embodiment 3 of the present invention. A current correction circuit 57 shown in FIG. 8 includes a correction current generating circuit 28 and a reference current generating circuit 59. Compared to the current correction circuit 27 shown in FIG. 3, the current correction circuit 57 shown in FIG. 8 is different in a configuration and a function of the reference current generating circuit. The description of the same points as the current correction circuit 27 is omitted, and the following describes only different points.

The reference current generating circuit 59 includes a PMOS current mirror transistor 31, a constant current transistor 30, circuit stop transistors 51, 52 and 53, and an inverter 54.

The circuit stop transistors 51, 52 and 53, and the inverter 54 serve as correction current ON/OFF circuit which switches between operations of generation and non-generation of a correction current performed by the current correction circuit 27.

Gates of the circuit stop transistor 51 and 53 are respectively connected to an ON/OFF control signal 50, which is for controlling the driving and non-driving of the current correction circuit 57.

Furthermore, a gate of the circuit stop transistor 52 is connected to a signal which is obtained by inverting the ON/OFF control signal 50 by using the inverter 54.

With this, while the current is constantly caused to flow to constantly drive the current correction circuit 27 shown in FIG. 3, the current correction circuit 57 according to this embodiment shown in FIG. 8 can be switched between ON/OFF for the operation of correction. Following describes the ON/OFF operation.

When a voltage level of the ON/OFF control signal 50 is set to HIGH, the current correction circuit 57 performs the same correction as the current correction circuit 27.

In contrast, when a voltage level of the ON/OFF control signal 50 is set to LOW, a gate potential of the constant current transistor 30 is electrically connected to the grounding line 10, and gate potential of the current mirror transistors 31 and 32 is electrically connected to the power supply line 23. Thus, the reference current and the correction current do not flow in the current correction circuit 57 and the correction operation is not performed.

It is to be noted that, in the same manner as the current correction circuit 27 described in Embodiment 1, the current correction circuit 57 in this embodiment is provided above and below each of the pixel columns. Furthermore, the ON/OFF control signal 50 is supplied to the current correction circuit 57, which is provided for each of the pixel columns, by a control line provided above and below the pixel array 1.

With the above configuration and operation, it is possible to switch the state of the current correction circuit between driven and non-driven. Thus, it is possible to lower power consumption compared to the case where the correction current is constantly caused to flow to constantly drive the current correction circuit.

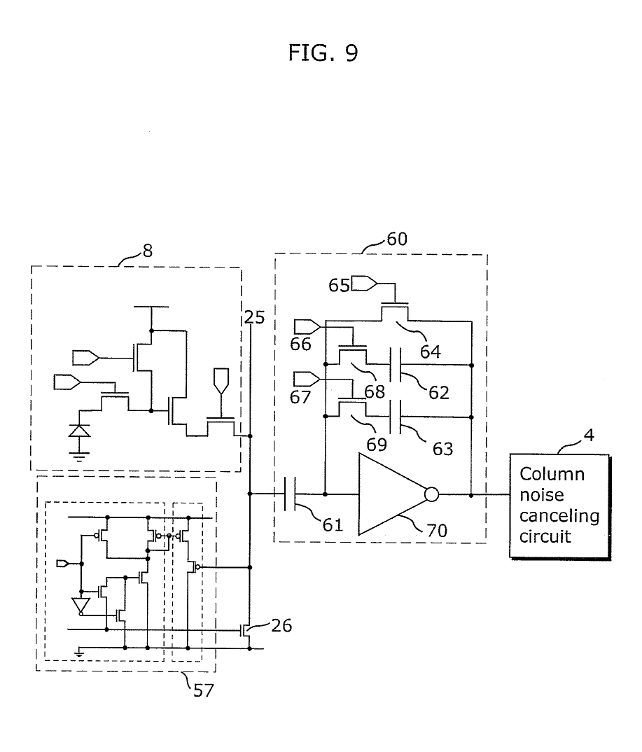

Furthermore, the camera according to Embodiment 3 of the present invention can perform control such that the ON/OFF control signal 50 supplied by the current correction circuit 57 and switching of gains of the column amplifier circuit operate in conjunction with each other. Following describes the control performed by the camera with reference to FIG. 9.

FIG. 9 is a circuit configuration diagram showing a column amplifier circuit included in a solid-state imaging device according to Embodiment 3 of the present invention. The column amplifier circuit 60, which is included in the solid-state imaging device 41, shown in FIG. 9 includes: an input capacitance 61, feedback capacitances 62 and 63, a reset transistor 64, and switching transistors 68 and 69, and an inverting amplifier 70.

The input capacitance 61 has one end connected to the column signal line 25, and the other end connected to an input terminal of the inverting amplifier 70.

The feedback capacitance 62 is connected to an output terminal of the inverting amplifier 70 and one end of the switching transistor 68. The feedback capacitance 63 is connected to an output side of the inverting amplifier 70 and one end of the switching transistor 69.

The reset transistor 64 is connected between an input and the output of an inverting amplifier 70.

The switching transistors 68 and 69 have, respectively, the other ends connected to an input side of the inverting amplifier 70. With the above described configuration, when the reset transistor 64 is caused to be in an ON state by setting a voltage level of a reset signal 65, which is connected to a gate of the reset transistor 64, to HIGH, the column amplifier circuit 60 is reset.

Furthermore, a gain of the column amplifier circuit 60 is determined based on a capacitance ratio of the input capacitance 61 and the feedback capacitance 62 and a capacitance ratio of the input capacitance 61 and the feedback capacitance 63. Thus, by causing one of the switching transistors 68 and 69 to be in ON state using gain switching signals 66 and 67 outputted by the DSP45, it is possible to switch between gains.

Furthermore, the DSP45 causes, in the above circuit configuration, the switching of gains and the ON/OFF control signal 50 of the current correction circuit 57 to operate in conjunction with each other, and thereby controls the ON/OFF of the current correction circuit 57 corresponding to a gain of the column amplifier circuit 60.

For example, when a gain of the column amplifier circuit 60 is high, the impact to an image quality made by the highlight horizontal line noise, which is generated due to a current fluctuation in a pixel source follower circuit, is significant. In contrast, when the above described gain is low, the impact to an image quality made by the current fluctuation in a pixel source follower circuit is not significant. Thus, by controlling the current correction circuit 57 such that the current correction circuit 57 is driven when the above described gain is high and the current correction circuit 57 is not driven when the above described gain is low, the DSP45 can suppress an increase in power consumption while reducing the highlight horizontal line noise effectively.

It is to be noted that the solid-state imaging device 41 and the camera according to this embodiment switches between two stages of gain. However, the solid-state imaging device 41 and the camera may include and switch between more than two stages of gain.

Furthermore, in the solid-state imaging device 41 and the camera according to this embodiment, the DSP45 performs control such that the driving and non-driving of the current correction circuit 57 operates in conjunction with the setting of a gain of the gain amplifier 43 which is included in an other IC than the IC of the solid-state imaging device 41. This is effective in suppressing the increase of the power consumption. More specifically, the current correction circuit 57 may be switched to a driven state when a gain of the gain amplifier 43 is high, and the current correction circuit 57 may be switched to a non-driven state when a gain of the gain amplifier 43 is low.

It is to be noted that the control of a gain of the column amplifier circuit 60 in conjunction with the driving and non-driving of the current correction circuit 57, and the control of a gain of the gain amplifier 43 in conjunction with the driving and non-driving of the current correction circuit 57 may be performed by an other control unit.

Furthermore, although the solid-state imaging device 41 and the camera according to this embodiment are structured to include each of functional blocks shown in FIG. 7 as a combination of individual parts, all the functional blocks or some of the functional blocks may be integrated in the same integrated circuit (IC). When the solid-state imaging device 41 and the camera are structured by combining individual parts, it is advantageous for reducing the cost of a device included in a camera. On the other hand, when functional blocks are integrated into the same IC, it is advantageous for enhancing a speed of the above described device.

While the solid-state imaging device and the camera according to the present invention has been described based on embodiments, the solid-state imaging device and the camera according to the present invention are not limited to these embodiments. The scope of the present invention includes: other embodiments that are realized by combining arbitrary constituent elements in Embodiments 1 to 3; various variation of the Embodiments 1 to 3 which will occur to those skilled in the art without departing from the fundamentals of the present invention; and various apparatuses which includes the solid-state imaging device and the camera according to the present invention.

For example, the configuration of the current correction circuit 27 according to Embodiment 2 may be applied to the solid-state imaging device 41 according to Embodiment 3. In other words, with a camera which includes a solid-state imaging device in which the reference current generating circuit unit is shared by the adjacent pixel columns, similar advantage as the solid-state imaging device and the camera according to Embodiment 3 is obtained.

It is to be noted that a conductivity type of respective transistor included in the solid-state imaging device and the camera according to the present invention is not limited to the conductivity type described in the above embodiments. Transistors of opposite conductivity type may be adopted as long as the function and the advantage of respective transistors described in Embodiments 1 to 3 are obtained.

Furthermore, embodiments according to the present invention have been described on the premise that respective transistors are FET which includes a gate, a source, and a drain. However, a bipolar transistor which includes a base, a collector, and an emitter may be adopted as long as the function and the advantage of respective transistors described in Embodiments 1 to 3 are obtained.

Furthermore, the pixel array 1 shown in FIG. 2 and FIG. 6 has a so called one-pixel-one-cell structure, that is, each of the pixel units 8 includes the photodiode 19, the transfer transistor 16, the floating diffusion 17, the reset transistor 14, and the amplifier transistor 20.

However, the pixel array included in the solid-state imaging device and the camera according to the present invention may have a so called multi-pixel-one-cell structure where each of the unit cells includes a plurality of photodiodes and the unit cells may share all or part of the floating diffusion, reset transistor, and amplifier transistor.

Furthermore, the solid-state imaging device and the camera according to the present invention may adopt a configuration in which the photodiode 19 shown in FIG. 2 is formed on a surface of a semiconductor substrate, that is, on the same side as a surface on which the gate and a line of the transistor are formed. Further, the solid-state imaging device and the camera according to the present invention may adopt a configuration of a so called a back illuminated image sensor (a back illuminated solid-state imaging device) in which the photodiode 19 is formed on a back side that is an opposite side of the surface on which the gate and the line of the transistor are formed.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The solid-state imaging device and the camera according to the present invention allow the realization of a camera which eliminates, when a subject of a high luminance is captured, deviation of black level which occurs to pixels around pixels which captured a high-luminance subject, and provide a high quality image in which the highlight horizontal line noise is reduced without generating an image defect in a form of a longitudinal line, and thus are useful for a digital still camera, a video camera, an in-vehicle cameras, a surveillance camera, and a camera for medical use and the like.

What is claimed is:

1. A solid-state imaging device in which a plurality of pixel units are arranged in rows and columns, each of said pixel units including a light-receiving element that generates a signal voltage corresponding to an intensity of light received,
wherein each of said pixel units includes
an amplifier element which amplifies the signal voltage in response to a flow of an operating current, and outputs the amplified signal voltage to a column signal line that is provided for each of pixel columns,
said solid-state imaging device comprising
current correction units each of which is provided for a corresponding one of the pixel columns and configured to cause a correction current to flow between a power supply line and a grounding line, the correction current fluctuating in an opposite direction to a fluctuation of the operating current flowing into the grounding line from the power supply line via said amplifier element.

2. The solid-state imaging device according to claim 1,
wherein each of said current correction units includes
a correction current generating circuit which causes the correction current to flow between the power supply line and the grounding line, the correction current being generated based on a fluctuation in potential of the column signal line.

3. The solid-state imaging device according to claim 2,
wherein at least one of said current correction units includes
a reference current generating circuit which causes a constant reference current to flow between the power supply line and the grounding line,
wherein said correction current generating circuit causes the correction current to flow between the power supply line and the grounding line, the correction current being generated based on a current-mirror current of the reference current and a fluctuation in potential of the column signal line.

4. The solid-state imaging device according to claim 3,
wherein said amplifier element is
a first amplifier transistor which includes a gate connected to a floating diffusion of a corresponding one of said pixel units, and a source and a drain one of which is connected to the power supply line, and which amplifies the signal voltage and outputs the amplified signal voltage to the column signal line from the other of the source and the drain,
said solid-state imaging device comprising
a first load transistor which includes a gate to which a bias voltage is applied, and a source and a drain one of which is connected to the column signal line and the other of the source and the drain is connected to the grounding line, said first load transistor generating the operating current,
said reference current generating circuit includes:
a second load transistor which includes a gate to which a bias voltage is applied, and a source and a drain one of which is connected to the grounding line, said second load transistor generating the reference current, and
a first current mirror transistor which includes a gate, and a source and a drain one of which is connected to the power supply line and the other of the source and the drain is connected to the other of the source and the drain of the second load transistor, the gate and the other of the source and the drain of said first current mirror transistor being short circuited,
said correction current generating circuit includes:
a second amplifier transistor which includes a gate connected to the one of the source and the drain of said first load transistor, and a source and a drain one of which is connected to the grounding line, said second amplifier transistor giving a potential that corresponds to a fluctuation in potential of the column signal line to the other of the source and the drain; and
a second current mirror transistor which includes a source and a drain one of which is connected to the power supply line and the other of the source and the drain is connected to the other of the source and the drain of said second amplifier transistor, and a gate connected to the gate of said first current mirror transistor, said second current mirror transistor generating the correction current.

5. The solid-state imaging device according to claim 4,
wherein a value of a bias voltage applied to the gate of said first load transistor is the same as a value of a bias voltage applied to the gate of said second load transistor.

6. The solid-state imaging device according to claim 1, wherein an amount of a fluctuation in a current, which is a sum of the operating current and the correction current, is smaller than an amount of a fluctuation in the operating current.

7. The solid-state imaging device according to claim 1,
wherein said current correction unit generates the correction current for full range of the intensity of light received.

8. The solid-state imaging device according to claim 1,
wherein at least one of said current correction units includes
a correction current ON/OFF circuit which switches between generation and non-generation of the correction current performed by said current correction unit.

9. A camera which includes the solid-state imaging device according to claim 8,
wherein said solid-state imaging device further includes
a column amplifier circuit which is connected to the column signal line and amplifies, for each of the pixel columns, by switching between a plurality of gains, a voltage outputted to the column signal line,
said camera comprising
a control unit configured to control the following switching operations in conjunction with each other: (i) the switching between gains performed by said column amplifier circuit and (ii) the switching between generation and non-generation of the correction current performed by said correction current ON/OFF circuit.

10. The camera according to claim 9 further comprising,
a gain amplifier which adjusts, with an appropriate gain, a gain of an image output voltage that corresponds to a voltage outputted by said solid-state imaging device,
wherein said control unit controls, according to a gain of said gain amplifier, the switching between generation and non-generation of the correction current performed by said correction current ON/OFF circuit.
